(19) United States
(12) Patent Application Publication
(10) Pub. No.: US 2016/0260017 A1
(43) Pub. Date: Sep. 8, 2016

(54) METHOD FOR ADAPTING USER INTERFACE AND FUNCTIONALITIES OF MOBILE APPLICATIONS ACCORDING TO THE USER EXPERTISE

(71) Applicant: SAMSUNG ELETRÔNICA DA AMAZÔNIA LTDA., CAMPINAS (BR)

(72) Inventors: THIAGO JOÃO VIOL VIEIRA, JAGUARIUNA (BR); MATEUS LEME PAZINI, AMERICANA (BR)

(73) Assignee: SAMSUNG ELETRÔNICA DA AMAZÔNIA LTDA., CAMPINAS (BR)

(21) Appl. No.: 14/662,748

(22) Filed: Mar. 19, 2015

(30) Foreign Application Priority Data
Mar. 5, 2015 (BR) 1020150049765

(51) Int. Cl. G06N 5/02; H04L 29/08

(52) U.S. Cl. CPC G06N 5/025; H04L 67/06

(57) ABSTRACT

The present invention provides a method comprising the steps of determining the level of user experience/expertise based on the general system settings; and adapting user interfaces and functionalities of applications (“apps”) in accordance with this level of user expertise. It also proposes an interface API that can expose the level of user expertise using applications (apps), so that they can dynamically adapt its own interface and features.

### CROSS-REFERENCE TO RELATED APPLICATIONS

This application claims the benefit of Brazilian Application No. 10 2015 004976 5, filed Mar. 5, 2015, in the Brazilian Intellectual Property Office, the disclosure of which is incorporated herein by reference.

### FIELD OF THE INVENTION

The present invention is related to user expertise (UX) and user interfaces (UIs) for mobile devices such as smartphones, tablets, wearable devices, notebooks, as well as non-mobile devices such as desktop computers and smart TVs.

### BACKGROUND OF THE INVENTION

Currently, when designing mobile applications, herein called “apps” in short, their user interfaces and functionalities are frequently limited taking into account a simpler design and logic of operation in order to reach a larger number of potential customers (from beginners to advanced users).

Systems frequently know little about user interests, preferences and experience. So, mobile devices and apps currently do not have enough information for providing a customized UI and functionality according to that user expertise.

Sometimes it is hard to accommodate the application complexity level, in terms of user interface and functionality, for both expert and beginner users. If application's UIs and functionalities are too complex for beginner users, they tend to abandon it, even though they could be suitable for more experienced users. On the other hand, a too simplistic UI may be convenient for a beginner user but it would prevent a more advanced user to take full advantage of more advanced application features.

The present invention introduces a method comprising the steps of:
determining the user expertise level based on general system settings; and
adapting the application's (“apps”) UIs and functionalities according to that user expertise level.

Moreover, it proposes an API interface which can expose the user expertise level to the apps, so that they may dynamically customize its own UI and functionalities.

The scope of the present invention is not limited to mobile devices and apps, but it may be extended to some smart devices, non-mobile devices which are able to download and execute external applications, such as smart TVs.

Similarly, the scope of this invention is not limited to the customization of the mobile applications, but it may be extended to the customization (UI and/or behavior) of the operating system itself and to a suite of applications (e.g. the UI framework).

The patent document WO 2000/031671 A1 titled: “Collection and analysis of user profile information”, by Andersen Consulting, published on Jun. 2, 2000, proposes a method to create and customize user interfaces in desktop personal computers (PCs) according to the user profile information based on Web and stored on a database of user profiles. The present invention differs from WO 2000/031671 A1 because:
the methods used to determine user behavior are different, while said WO 2000/031671 A1 performs statistics treatment based on user profile, the present invention estimates the user expertise level based on internal parameters of the device;
the information sources are different, while the document WO 2000/031671 A1 uses network interfaces do search remotely data stored on Web or databases, the present invention searches user expertise information stored locally in the device, using parameters settings and user behaviors together with the device; and
the target devices are different: while document WO 2000/031671 A1 is uniquely directed to user interfaces on Web of desktop personal computers, the present invention is mainly applied to mobile devices and mobile applications (“apps”), also extending to other devices: smartphones, tablets, ultrabooks, laptops, smart TVs, wearable devices, etc.

While document WO 2000/031671 A1 applies the results of user profiles uniquely to the web UI setting of the PC desktop, the present invention applies the results of the user expertise estimative to the own system, external systems and to any other functionalities taking into account the user expertise and the use of the system: market analysis, advertising campaigns, business intelligence (BI), different levels of difficulty in games, among others.

The patent document WO 2010/074868 A1 titled: “Interface Adaptation System”, by Symbol Technologies, published on Jul. 1, 2010, proposes ways for automatically adapting the user interface of a device in response to the manner in which a user physically operates the device and the conditions surrounding operation in order to optimize usability of the device. The present invention differs from WO 2010/074868 A1 because the patent document WO 2010/074868 A1 is related to how users hold a device (left/right/both hands, stylus, etc.) as well as the environment parameters (such as orientation of device, temperature, pressure, etc.) and these items are input to adapt the user interface only while the present invention does not take into account environment neither anatomically factors to build knowledge about the user. Also the collected user's info by the method of the present invention can be used by outside systems (not just the own system) to take decisions on behavior (not just user interface but a variety of things such as logic change, difficulty level if it is a game per example, contextual information, etc.).

The patent document U.S. Pat. No. 7,526,459 B2 titled: “Adaptive Social and Process Network Systems”, by Manyworlds, published on Apr. 29, 2009, proposes ways to measure and analyze social networks systems. The present invention differs from U.S. Pat. No. 7,526,459 B2 because:
its context is mainly related to group/community social networks while the present invention determines the individual user behavior.
the types of statistics data are different to determine user behavior, which has as its main objective to adapt the interface and mobile applications according to the user expertise.
the way how user info is used is different (social networks recommendations versus adaptation of system's logic/interface).

The patent document U.S. Pat. No. 7,792,661 B1 titled: “Real time Feature Adaptation Responsive to Dynamically Gathered Usability Information”, by Symantec Corp, published on Sep. 7, 2010, describes a mechanism for adapting application features in real time, based on dynamically gathered usability information. Such adaptation is accomplished by removing, adding or simplifying of application components, relying on an external server to process the adaptation decision. The present invention differs from document U.S. Pat. No. 7,792,661 B1 by describing a more flexible and broader approach wherein application can internally modify its own look (UI) and behavior, taking advantage of a user expertise level estimation ranking, mainly based on the mobile operating system settings. In addition, the present invention describes expertise levels per more specific feature categories (e.g. Multimedia, Connectivity, Social, Messaging) for a more accurate adaptation, besides defining a global feature category for more generic adaptations.

The patent document US 2013/014040 Al titled: “Application Relevance Determination Base on Social Context”, by Qualcomm, published on Jan. 10, 2013, describes a system that determines the relevance of the application by means of a score based on social context and the graphical user interface (GUI) is reorganized and resized. The present invention differs from US 2013/014040 A1 by describing a broader approach, in which the application can internally change their own appearance (UI) and behaviors, using an estimated classification (“ranking”) of the user expertise mainly based on the device's operating system settings. In addition, the present invention describes the levels of experience/ expertise for more specific categories of features (e.g., multimedia, connectivity, Social Networks, Messaging) for a more accurate adjustment, not limited to the social context and further defines a category of global functionality to more general adjustments on the mobile device.

The paper “Contextual Adaptive User Interface for Android Devices”, by Samsung R&D Institute Bangalore India, proposes a framework to adapt the user interface (UI) of mobile computing devices like smartphones or tablets, based on the context or scenario in which user is present, and incorporating learning from past user actions. It allows the user to perform actions in minimal steps and also reduce the clutter. The user interface in question can include application icons, menus, buttons window positioning or layout, color scheme and so on. The framework profiles the user device usage pattern and uses machine learning algorithms to predict the best possible screen configuration with respect to the user context. The present invention differs from said paper in the following aspects:
the present invention is not limited to the adaptation of UIs, but it also extends to the adaptation of the behavior and functionalities.
the present invention presents feature categories of expertise and proposes scores to measure level of user expertise on those categories.
the present invention also presents a global expertise parameter which can quickly indicate user overall expertise in the device's technology.

The scores for key feature categories can be exposed as an API to be queried by any mobile application, either preloaded or downloaded from App Stores, for example. Once feature areas values are accessed the SW programs (per example: applications), they can benefit from such information to adapt their user interface in the proper way.

The adaptive user interface (AUI) (available at http://en.wikipedia.org/wiki/Adaptive user interface) is a user interface (UI) which adapts itself, that is, changes in its layout and elements to the user needs or context and it is similarly alterable for each user.

The advantages of an adaptive user interface are found within its ability to meet user's needs. The properties of an AUI allow showing only the relevant information based on the current user. It creates less confusion for less experienced users and provides easy access to the entire system.

It may mean that for a user with basic knowledge of a system, only minimal information is displayed. On the other hand, a user with advanced knowledge will have access to more detailed information and capabilities. The present invention is not limited to the adaptation of user interfaces, but it also extends to the adaptation of the behavior and available functionalities. Additionally, the present invention defines feature areas and conditions to rank the expertise level by category. This expertise level can be internally available to mobile application as well as to external systems for use in market campaigns, for example.

### SUMMARY OF THE INVENTION

The present invention refers to a method which allows a mobile device to determine the expertise level of its user, so that mobile applications can adapt their user interfaces (UIs) and functionalities based on that level. Expertise levels may be determined by specific feature categories or a global expertise level may be achieved. Examples of specific feature categories are: Connectivity, Messaging, Web Browsing, Social Networks, Multimedia and Accessibility. The more experienced/interested is the user, the more advanced will be the UI and related functionalities made available to him/her.

By considering the device settings preferences, mobile applications may be designed to offer the best in class UIs and functionalities without worrying about the end user expertise in a given technology once this information is provided by the device. The concept may extend from downloadable mobile applications to pre-loaded applications, the suite of applications (framework) and the operating system itself.

The expertise level is determined by analyzing the mobile operating system (e.g. Android, Apple IOS or Windows Phone) settings, among other parameters, and applying rules which evaluate how simple or complex those settings/parameters are.

An Application Programming Interface (API) may be exposed to provide the current user expertise level by feature area or a general level.

This mechanism allows mobile applications (or operating system) to invoke those APIs to dynamically adapt/customize their own UIs and functionalities according to the current user expertise level.

The objectives and advantages mentioned are achieved by a method to adapt a user interface and functionalities of an application according to the user expertise that comprises the steps of:
specifying the appearance and actions/behaviors of the application for every level of user expertise;
defining rules for tracking/mapping user actions and behaviors during the use of the device;
associating the values for each level of user expertise that is being monitored in order to determine the degree of user expertise within an available range; and
associating in a single parameter how much the user is familiar with the device technology and allowing other software programs to read it in order to dynamically change their behavior.

A given level of expertise on a specific area, for example messaging, may use to customize the UI and functionalities of a messaging-specific application or that information may be cross-used to infer the user level in other types of apps, for example, social network applications.

### BRIEF DESCRIPTION OF THE FIGURES

The patent or application file contains at least one drawing executed in color. Copies of this patent or patent application publication with color drawings will be provided by the Office upon request and payment of the necessary fee. The objectives and advantages of the present invention will become more clear by means of the following detailed description of a preferred but non-limitative embodiment of the invention, in view of its appended figures, wherein:

FIG. 1 shows a blocks diagram of the method operation according to an example embodiment of the present invention;

FIG. 2 shows a classification table of the user expertise levels according to an example embodiment of the present invention.

FIG. 3 shows a diagram of an application using an expertise level according to an example embodiment of the present invention.

FIG. 4 shows an example of user interface adaptation based on user expertise information, according to an example embodiment of the present invention.

### DETAILED DESCRIPTION OF THE PRESENT INVENTION

The present invention refers to a method which allows applications to adapt their UIs and functionalities according to the of user expertise level on the mobile device on certain feature categories.

The user expertise level may be specified by feature categories as values ranging from the lowest level representing the beginner user up to the higher level representing the expert user. The table below demonstrates an example of user expertise level classification:

TABLE 1

| Level | Expertise |
|---|---|
| 0 a 2 | Begginer |
| 3 | Intermediate |
| 4 a 5 | Expert |

The user expertise levels are determined by feature categories as in the examples below:
Social: usage of social networks, blogs (accounts, their quantity, kinds and frequency of usage).
Web Browsing: do web navigation with Internet Browser applications, download applications on mobile stores, files transfers, location based contextualized information (maps, latitude/longitude, etc.).
Messaging: use of text messaging, Instant Messaging and E-mail.
Media: play or record videos, take pictures, access pictures gallery, listen to music, watch TV, read e-books.
Connectivity: variety and quantity of mobile and wired Connections used by the user.
Finance: do bank transactions, do budgets/quotes, buy things (Applications, NFC technology, Browser, e-wallet).
Voice: do voice calls.
Accessibility: use accessibility features and applications to determine if user has limitation on vision, hearing, movements and other.
Location: coordinates (latitude and longitude) and altitude information that can determine statistically frequency that user moves or use GPS.
Example of possible scores for each user expertise above: from beginner (lower level) to expert (higher level), according to Table 1.

The user expertise level per feature category are determined taking into consideration operating system settings and user behavior parameters such as the following:
Social: number of accounts created on device for Social Networks (SNS), number of SNS applications installed, number of contacts and friends, internet browser navigation history, bookmarks containing SNS information, frequency of use of SNS, time spent using SNS.
Web Browser: number of bookmarked pages, time spent using browser, number of applications downloaded from browser, internet related features enabled (such as tethering, hotspot), data package volume.
Messaging and e-mail: number of sent/received text messages, e-mails, Instant Messages sent/received, amount of time spent on these applications, number of contacts in these application's mailboxes and agendas.
Media: number of media files on device (pictures, videos, audio, e-book), frequency on how they are accessed.
Connectivity: paired stereo BT headsets, media features enabled on device (such as Wi-Fi-direct, S-Beam, All share, NFC).
Finance: (Google) wallet configured, purchase of applications from stores (Samsung apps, Google play, Apple store), use of applications that do online stocks quotation, installed stock related applications.
Voice: number of contacts with phone number, recent calls list, duration of calls, frequency of calls.
Accessibility: accessibility settings turned on, frequency of use of smart scroll, air gestures, voice commands.
Location: GPS usage, coordinates (latitude and longitude) information, altitude information, time spent on a given, frequency that a given coordinate is visited. In addition, Location information if linked to external data sources, may allow the use of geographic or demographic parameters in the user expertise profiling determination and further UI/behavior customization.

There can be also a GLOBAL expertise level which can provide an overall measurement on how familiar the user is with device's features/technology. It may be calculated taking into consideration the above values, or a subset of them.

FIG. 1 presents an overview of the invention where the mobile device is able to collect user behavior data from parameter settings 101 and evaluating rules of the user expertise 102 to determine the level of user expertise per feature category (and globally), stores the user expertise level in the database 103 and expose such parameters values to allow applications to adapt their user interfaces (UIs) and functionalities of apps 104, of the operating system 105 or share these information with external systems 106.

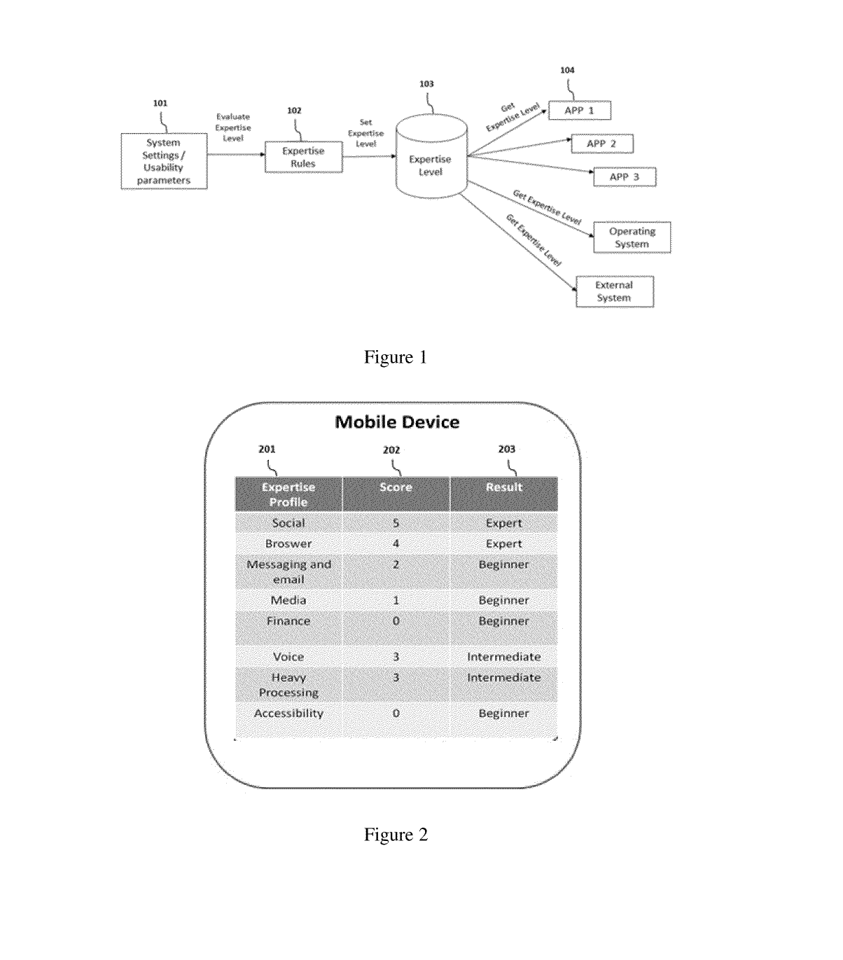

FIG. 2 describes an example on how the expertise levels information can be classified in a device. The table of FIG. 2 shows possible areas 201 with their scores 202 and ranking 203. This table is read by mobile applications that can benefit from such information to dynamically adjust their user interfaces and functionalities (offered features, customized advertisements, alerts and so on).

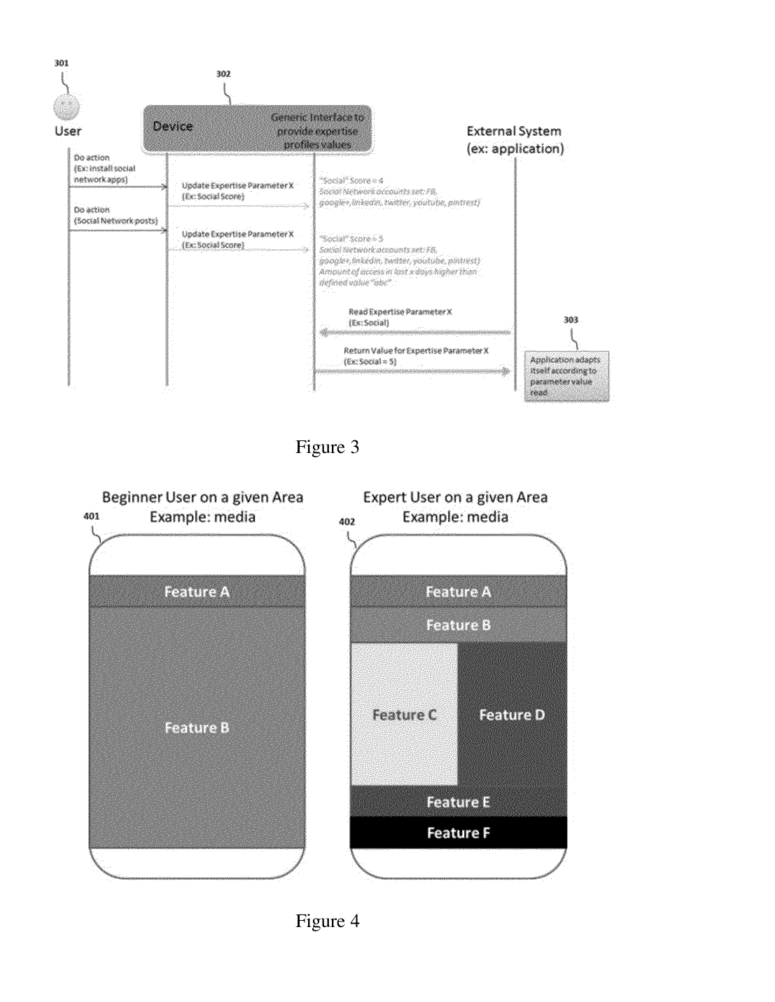

FIG. 3 describes interaction between user, device and application. The user performs actions 301 that are statistically used to update the respective expertise level 302 parameter. Then an application 303 reads such parameter value.

FIG. 4 illustrates two different UI screens according to expertise levels values detected by the application. The example indicates how different the application can behave according to the expertise levels values read. The application can benefit from such information in order to show/hide to user an UI only with what is really relevant to him. FIG. 4 shows an example of functionality and/or user interface available to a beginner user 401 and an expert user 402.

The application that is reading the expertise levels can offer a confirmation message to user before show a customized application UI or user expertise, according to the application developer. Providing the option to user decides which mode to run the application allows other users (not the device owner) to also use it in a good way.

Applications—Downloadable apps, pre-loaded apps, suite of applications and operating system itself can take advantage of the user expertise levels, as follows:

The more the user uses the device, the more it knows about the user and the more accurate are calculated the user expertise levels. The learning is achieved by determining the expertise level based on the attributes (operating system settings and user behavior parameters) listed above, per feature category, and storing them in a local or external database 103 (see FIG. 1).

Based on this learning process, the applications automatically adapt themselves (UI and functionalities) according to the attributes and expertise levels previously stored in that expertise level database 103. Once such information is retrieved, the mobile device adapts/customizes itself by configuring its own UI and available functionalities (see FIGS. 2, 3 and 4).

As an example of adaptation, even the complexity of the app settings options available to the user may also be adjusted (advanced or simple settings).

External systems may also take advantage of the estimated values of user expertise 106 information, by collecting and using them for product development/improvements, market research, business intelligence or advertisement campaigns.

Device's operating system and suite of applications (e.g. UI framework) can take advantage of the invention 105 by offering completely different user interfaces based on user expertise, offering or hiding sets of features according to the estimated values of user expertise.

Although the present invention has been described in connection with certain preferred embodiments, it should be understood that it is not intended to limit the invention to those particular embodiments. Rather, it is intended to cover all alternatives, modifications and equivalents possible within the spirit and scope of the invention as defined by the appended claims.

What is claimed is:

1. A method for adapting a user interface and mobile application features according to the user expertise characterized by comprising the steps of:
specifying the application appearance and actions/behaviors for every level of user expertise;
defining rules for tracking/mapping user actions and behaviors during use of the device (102);
associating the values for each level of user expertise that is being monitored in order to determine the degree of user expertise within an available range (103); and
associating in a single parameter how the user is familiar with the device technology and allow other software programs to read it in order to dynamically change their behavior (104).

2. Method according to claim 1, characterized by the fact that the experience level of feature category is determined by the operating system settings (101) and user behavior parameters (102).

3. Method according to claim 1, characterized by the fact that the feature categories comprise one or more of the social, browsing, messaging, media, connectivity, finance, voice, accessibility and location (201).

4. Method according to claim 1, characterized by the fact that the level of overall experience is calculated based on a user's experience level category or a subset thereof.

5. Method according to claim 1, characterized by the fact that the applications can be downloaded via the Internet applications, preloaded applications, the suite of applications (framework) (106) and the operating system itself (105).

6. Method according to claim 1, characterized by the fact that analyzes aspects of user behavior (301) and use of the device, including but not limited to, the use and quantity of installed applications, frequency and duration of network connections used, numbers of visits/marked sites, sending/receiving SMS messages, voice/video calls, volume of data packets, number of media types, number of contacts, memory usage and CPU.

7. Method according to claim 1, characterized by the fact that the expertise values (202) by category (201) or globally are stored in the user device itself or in the cloud.

8. Method according to claim 1, characterized by the fact that each level of expertise takes on values that represent a smaller scale ranging from experience, or beginner (401), to the highest level of experience or specialist (402) with one or more intermediate values (203).
